(19) United States
(12) Patent Application Publication
(10) Pub. No.: US 2026/0367242 A1
(43) Pub. Date: Nov. 19, 2026

(54) FIRST RESPONDER TRACKING AND COMMUNICATION SYSTEM

(71) Applicants: Baabi Das, Arlington, VA (US); Maurice Jackson, COLORADO SPRINGS, CO (US)

(72) Inventors: Baabi Das, Arlington, VA (US); Maurice Jackson, COLORADO SPRINGS, CO (US)

(73) Assignee: Zansors LLC, Arlington, VA (US)

(21) Appl. No.: 19/142,795

(22) PCT Filed: Dec. 29, 2023
(86) PCT No.: PCT/US2023/086362

§ 371 Date: Jun. 24, 2025

Related U.S. Application Data
(60) Provisional application No. 63/436,157, filed on Dec. 30, 2022.

(51) Int. Cl. G01S 13/86; G01S 13/70; G06F 3/147; G06Q 50/26; H04W 4/029; H04W 84/12

(52) U.S. Cl. CPC G01S 13/86; G01S 13/70; G06F 3/147; G06Q 50/265; H04W 4/029; H04W 84/12

(57) ABSTRACT

The present invention discloses a first responder tracking and communication system and method. The system comprises one or more wearable devices. Each wearable device is associated with at least one first user, and each wearable device is configured to function as a node to form a mesh network among the wearable devices. The wearable device is configured to enable the first user to track and communicate with other first users. The system further comprises at least one user device associated with a second user. The first user is a first responder and the second user is an incident commander. Further, a computing device in communication with the wearable devices and the user device. The computing device is configured to receive data related to the first responder, and enable three-dimensional tracking and communication among the responders and with the incident commander.

### CROSS-REFERENCE TO RELATED APPLICATIONS

This application claims priority to PCT International application No. PCT/US2023/086362, filed on Dec. 29, 2023, which further claims the priority of U.S. Provisional Patent Application 63/436,157, filed on Dec. 30, 2022, the entire contents of which are incorporated herein by reference.

### TECHNICAL FIELD

The present invention generally relates to tracking and communication system, and, more particularly, to first responder tracking and communication system and method.

### BACKGROUND

First responders are organizations and personnel that provide law enforcement, safety and protection services to the public. The first responders include law enforcement officers, and fire and safety personnel, for example, police, sheriff, highway patrol, detectives, special law enforcement, firefighters, war fighters, emergency medical services personnel, Red Cross personnel, and other emergency workers.

During an indoor incident, the first responders need to deal with number of unpredictable situations, for example, building structure, intensity of disaster and number of responders needed may increase depending upon the situation. In these situations, the responders need situational awareness to successfully complete the operation without any loss of personnel. For example, during a fire incident, if a door to a particular room is blocked and a responder is trapped in the room with the civilian. The incident commander, or a fellow first responder in the vicinity of the room needs to be aware of the situation to save the trapped responder and civilian. However, with the existing conventional system, the trapped responder can only transfer message that he has trapped inside room. The conventional system includes talk-radios to communicate with fellow first responders or incident commander. Sometimes, depending upon the structure and location of the room, for example, an underground room, even transferring message is not possible. The incident commander and fellow first responders have to search through the whole building to find the location of the trapped first responder and civilian. However, during such situation, searching the entire building is not even an option and mostly result in casualties.

Few patent application reference attempts to address the problems cited in the background as prior art over the presently disclosed subject matter and are explained as follows.

A prior art U.S. Pat. No. 8,706,414 assigned to Benjamin E. Funk et al. entitled “method and system for locating and monitoring first responders” discloses methods and systems for locating and monitoring the status of people and moveable assets, such as first responders. The system and method use inertial navigation to determine the location, motion and orientation of the personnel or assets and communicates with an external monitoring station to receive requests for location, motion orientation and status information and to transmit the location, motion orientation and status information to the monitoring station.

Another prior art U.S. Pat. No. 11,051,156 assigned to Patrick O'Connor et al. entitled “tracking and accountability device and system” discloses a first personal tracking unit (PTU) is configured to be worn to determine their location within a structure. The PTU is in communication with a wireless communication network and it is operative to transmit signals of the location data to a command unit. The system generates a visual illustration of an ambient temperature data and the location data obtained from each of the first and second PTU in the form of a map. The measurements from an accelerometer and gyroscope or MEMS sensor allow the system to determine the position and orientation of the PTU. However, the existing system lacks to ensure seamless communication and tracking in any type of environment.

Therefore, there is a need for a system and a method that facilities to track the location of the first responders in both indoor and outdoor environment. Further, the system and method need to enable communication among the first responders and with the incident commander. Further, the system and method need to facilitate the first responders to track the location of other first responders in the incident environment and enable to communicate with the other first responders in the incident environment.

### SUMMARY

The present invention discloses a system and method for tracking and communicating with first responders. The system comprises one or more wearable devices, at least one user device and a computing device. Each wearable device is associated with a first responder dispatched at an incident environment. The user device is associated with a second user. The second user is an incident commander. The computing device is in communication with the wearable devices and the user device.

Each wearable device is configured to function as a node and communicate with other wearable devices in real time and form a wireless mesh network. Each wearable device comprises a controller, a communication module connected to the controller and an inertial measurement unit in communication with the controller. The communication module comprises ultrawideband (UWB), Bluetooth (BLE) and Zigbee. In one embodiment, the inertial measurement unit comprises 3 axis accelerometer, 3 axis gyroscope and magnetometer. Each wearable device is configured to perform autonomous computing and transmit location tracking data in real-time to the computing device. The location data is determined using time of flight data between the wearable devices.

The computing device is configured to receive location tracking data of each wearable device. The computing device enables to view location tracking data of each wearable device in real time via the user device. The location tracking data includes location of each first responder, distance between each first responders, a floor at where each first responder is located, a distance travelled by the first responder, an orientation of the first responder and a direction of movement of the first responder. The computing device further enables to communicate with the first responders via the user device.

The wearable device further comprises one or more biometric sensors and medical sensors in communication with the controller configured to transmit health-related data of the first responder to the computing device.

The wearable device further comprises a microphone in communication with the controller, a memory in communication with the controller, one or more connector ports in communication with the controller, and one or more control buttons in communication with the controller. The control buttons are configured to enable the first responder to control the wearable device. The wearable device further comprises a power source to supply power to the wearable device, and at least one display in communication with the controller to display information related to the first responders. In one embodiment, the display is an egocentric display configured to display range, bearing, azimuth and elevation of the first responders in an incident environment. In one embodiment, the connector port comprises a liquid display connector port, a battery connector port, and an external device connector port. The wearable device further comprises a pressure sensor, and an altimeter in communication with the controller. Further, each wearable device comprises a unique identifier. Each wearable device is configured to receive and process time of flight data of a radio signal to provide location of the responders. Further, each wearable device is configured with autonomous computing and edge-computing. Furthermore, each wearable device is configured with multipath fading immunity and ingress protection.

The computing device is configured to enable the second user to view health-related data of each first responder in real time. The computing device is further configured to display range, bearing, azimuth and elevation of the first responders with respect to a reference location at the user device. The computing device is configured to provide situational awareness from a moment the first responders are deployed to till an end of a rescue operation at the incident environment. In one embodiment, the incident environment includes indoor environment and outdoor environment.

Other objects, features and advantages of the present innovation will become apparent from the following detailed description. It should be understood, however, that the detailed description and the specific examples, while indicating specific embodiments of the innovation, are given by way of illustration only, since various changes and modifications within the spirit and scope of the innovation will become apparent to those skilled in the art from this detailed description.

### BRIEF DESCRIPTION OF THE DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates an environment of a first responder tracking and communication system, according to an embodiment of the present invention.

FIG. 2 exemplarily illustrates a printed circuit board of the wearable device of FIG. 1.

FIG. 3 exemplarily illustrates a screenshot of a user interface displayed to the incident commander, according to an embodiment of the present invention.

FIG. 4A exemplarily illustrates a graph indicating the movement of the first responders from the data of accelerometer, according to an embodiment of the present invention.

FIG. 4B exemplarily illustrates a graph indicating the orientation of the first responders from the data of magnetometer, according to an embodiment of the present invention.

FIG. 4C exemplarily illustrates a model generated by tracking the movement and orientation of the first responders from FIG. 4A and FIG. 4B.

FIG. 5A exemplarily illustrates a graph indicating the movement of the first responders from the data of accelerometer, according to another embodiment of the present invention.

FIG. 5B exemplarily illustrates a graph indicating the orientation of the first responders from the data of magnetometer, according to another embodiment of the present invention.

FIG. 5C exemplarily illustrates a model generated by tracking the movement and orientation of the first responders from FIG. 5A and FIG. 5B.

FIG. 6A exemplarily illustrates a graph indicating the movement of the first responders from the data of accelerometer, according to yet another embodiment of the present invention.

FIG. 6B exemplarily illustrates a graph indicating the orientation of the first responders from the data of magnetometer, according to yet another embodiment of the present invention.

FIG. 6C exemplarily illustrates a model generated by tracking the movement and orientation of the first responders from FIG. 6A and FIG. 6B.

FIG. 7A exemplarily illustrates a graph indicating the movement of the first responders from the data of accelerometer, according to yet another embodiment of the present invention.

FIG. 7B exemplarily illustrates a graph indicating the orientation of the first responders from the data of magnetometer, according to yet another embodiment of the present invention.

FIG. 7C exemplarily illustrates a model generated by tracking the movement and orientation of the first responders from FIG. 7A and FIG. 7B.

FIG. 8 exemplarily illustrates a model provided by the system that represents the first responders ascending and descending the stairs, according to an embodiment of the present invention.

FIG. 9 exemplarily illustrates a perspective view of the wearable device of FIG. 1.

FIG. 10 exemplarily illustrates a block diagram of the components of the wearable device of FIG. 1.

### DETAILED DESCRIPTION OF EXAMPLE EMBODIMENTS

A description of embodiments of the present innovation will now be given with reference to the Figures. It is expected that the present innovation may be embodied in other specific forms without departing from its spirit or essential characteristics. The described embodiments are to be considered in all respects only as illustrative and not restrictive.

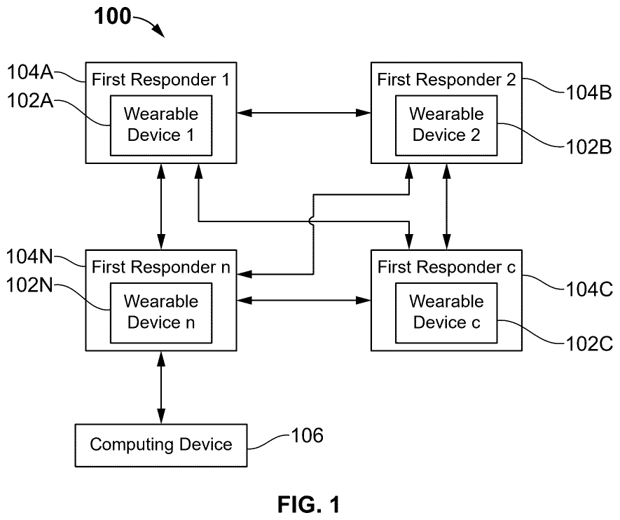

FIG. 1 exemplarily illustrates an environment 100 of a system for tracking and communicating with first responders, according to an embodiment of the present invention. The system comprises one or more wearable devices (102A, 102B, 102C, 102N) associated with first users, for example, first responders (104A, 104B, 104C, 104N). At least one wearable device (102A, 102B, 102C, 102N) is associated with at least one first responder (104A, 104B, 104C, 104N). The wearable devices 102A, 102B, 102C 102N hereinafter commonly referred as wearable devices 102, or devices 102. The first responders (104A, 104B, 104C, 104N) hereinafter commonly referred as first responders 104, or responders 104.

Each device 102 is configured to function as a node. Further, the devices 102 are configured to communicate node-to-node in real-time and create a mesh network among each wearable device 102. The system further comprises a computing device 106 configured to receive data from the wearable devices 102. The computing device 106 is configured to receive and display data related to the first responders 104. The computing device 106 enables to track and communicate with the first responders 104.

The system further comprises a user device associated with a second user, for example, an incident commander to access the computing device 106 to track and communicate with the first responders 104. The user device may be, for example, a desktop computer, a laptop computer, a mobile phone, a tablet, a personal digital assistant, and the like. The user device is configured to execute one or more client applications such as, without limitation, a web browser to access and view content over a computer network, an email client to send and retrieve emails, an instant messaging client for communicating with other users, and a File Transfer Protocol (FTP) client for file transfer. The user device in various embodiments, may include a Wireless Application Protocol (WAP) browser or other wireless or mobile device protocol suites.

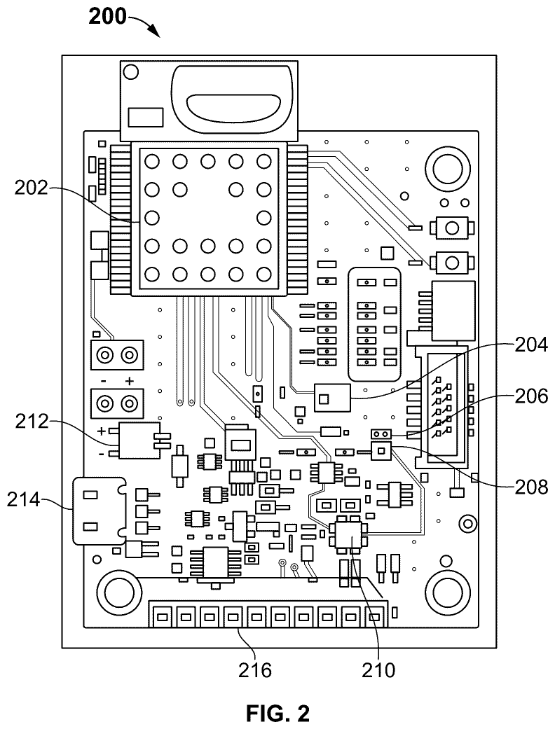

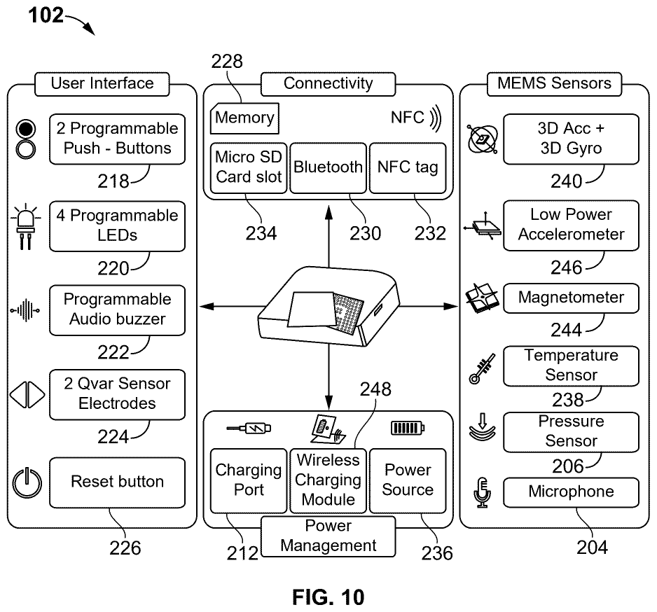

The wearable device 102 comprises one or more solid-state inertial measurement units (IMU) 210 integrated with the ultrawideband (UWB) radio to receive and process time-of-flight data., shown in FIG. 2. The IMU 210 includes one or more sensors including, but not limited to, 3-axis accelerometer and 3-axis gyroscope 240, magnetometer 244 and low power accelerometer 246 (shown in FIG. 10). The wearable device 102 includes one or more biometric sensors, and medical sensors. The device 102 is further configured to perform autonomous computing and transmit data in real-time to the computing device 106, thereby eliminating the need for pre-deployed infrastructure. Thereby, the wearable devices 102 together form a mesh communication network and provides three-dimensional tracking of first responders 104 at an indoor environment. Further, the device 102 enables the incident commander to view the real time data related to the location of the first responders 104 at the indoor environment. The system enhances the mesh network capabilities between each wearable device 102 node.

The device 102 is configured to perform autonomous computing and transmit location tracking data in real-time to the computing device 106. The location tracking data is determined using time of flight data between the wearable devices 102. The device 102 is configured to provide location of the first responders 104 with at least 1 meter accuracy. In another embodiment, the device 102 is configured provide location of the first responders 104 with at least 2 meter accuracy. The computing device 106 is configured to receive location tracking data of each wearable device 102. The computing device 106 is configured to enable to view location tracking data of each wearable device 102 in real time via the user device. The location tracking data includes location of each first responder, distance between each first responders, a floor at where each first responder is located, a distance travelled by the first responder, an orientation of the first responder and a direction of movement of the first responder. The computing device 106 further enables to communicate with the first responders via the user device.

The computing device 106 is configured to enable the second user to view health-related data of each first responder in real time. The computing device 106 is further configured to display range, bearing, azimuth and elevation of the first responders with respect to a reference location at the user device. The computing device 106 is configured to provide situational awareness from a moment the first responders are deployed to till an end of a rescue operation at the incident environment.

Referring to FIG. 2 and FIG. 10, the printed circuit board 200 comprises a controller with embedded algorithms and one or more microelectronic components in communication with the controller. The microelectronics, including, but not limited to, ultrawideband (UWB) 202, pressure sensor 206, temperature sensor 238, microphone 204, altimeter 208, memory chip or memory 228, storage chip, liquid display connector port 216, micro-processor and inertial measurement unit 210 including 3-axis accelerometer and 3-axis gyroscope 240, magnetometer 244 and low power accelerometer 246. The printed circuit board 200 further comprises one or more ports in communication with the controller to connect with external devices. The ports include a battery connector port or charging port 212, and an external device connector port 214. The microphone 204 enables the first responders to communicate with stored/saved contacts.

The ultrawideband 202 uses radio technology that could enable very accurate measure of the time of flight of the radio signal, leading to provide location of the responders 104 with less than 1 meter accuracy. The custom PCB 200 is designed to be reliable for indoor locations by achieving strong immunity to multipath and interference, for example, walls. The device 102 further comprises a power supply or power source 236. In one embodiment, the power supply is a rechargeable lithium-ion battery. The device 102 is configured with autonomous computing and edge-computing. The device 102 is further configured with IEEE standard 802.154z to give physical layer security using distance-time bounded protocols. The device 102 further includes one or more control buttons that facilitates the user to control the device 102. The control buttons include, but not limited to, ON button and an OFF button. The device 102 further comprises a display. In one embodiment, the display is configured to display range and bearing of one or more responders 104 to the incident commander and the responders 104. In another embodiment, the display is an egocentric display configured to display azimuth and elevation. The display is further configured to display real time data related to the first responders 104. In one embodiment, the display is a liquid crystal display (LCD) display.

The wearable device 102 further includes one or more biometric sensors, and medical sensors, which are configured to transmit data related to the health attributes of the first responder 104 to the computing device 106. The incident commander is enabled to track the health attributes of the first responder 104 via the user device. The device 102 further comprises one or more programmable push buttons 218, one or more programmable light emitting diodes (LEDs) 220, programmable audio buzzer 222, sensor electrodes 224 and reset buttons 226 connected to the controller. The device 102 further comprises a slot 234 to receive the memory 228, and Bluetooth 230 and NFC tag 232 for communication with third party devices or other wearable devices 102. The device 102 further comprises a wireless charging module 248 for wireless charging of the device 102.

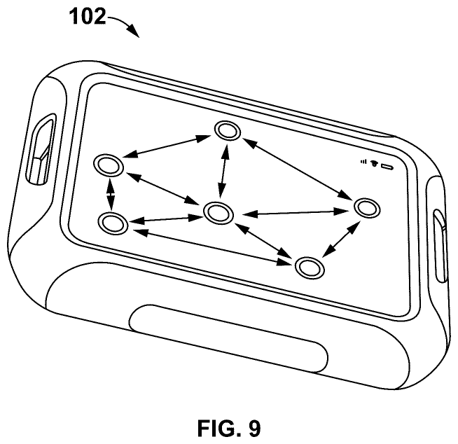

Referring to FIG. 9, the wearable device 102 has a compact structure and could be worn on the wrist or any part of the body. In one embodiment, the device 102 is adapted to be worn on the wrist of the first responder 104. In another embodiment, the device 102 is provided as a clip-on wearable device. In yet another embodiment, the device 102 could be carried in a pocket of the first responder 104. In yet another embodiment, the device 102 is adapted to be worn on the body of the first responder 104, for example, the chest of the first responder 104. In one embodiment, the wearable device 102 could be worn using a tether. In another embodiment, the wearable device 102 could be worn using a retractable tether. The wearable device 102 is a low cost, compact, light-weight device. In an example, the device 102 is 2″×3″ in size and weighs around about 2 oz. In another example, the device 102 is 1″×1″ in size and weighs around 1.5 oz,

The device 102 is configured to determine real-time range and bearing from the first responders 104 and a reference location. In one embodiment, the reference location refers to the location of the incident commander. In one embodiment, the real-time range and bearing are calculated using algorithms based on dead reckoning, two-way ranging (TWR), time difference of arrival (TDOA), and phase difference of arrival (PDoA) calculations. Each wearable device 102 associated with the first responder 104 is configured to function as a node and configured to perform autonomous computing between nodes.

The wearable device 102 includes a communication module. The communication module is a wireless communication module including ultrawideband 202 and Bluetooth (BLE) to determine the range between nodes. The communication module further includes ZigBee. The limitations may include Packet Error Rate (PER) and receiver blocking rates. In an example, the device 102 has typical blocking levels to give 1% UWB PER at 3 dB back off from the sensitivity point. The device 102 is configured to operate in different categories of first responder 104 settings, for example, firefighter, war fighter, medical service, and law enforcement environments. The device 102 is configured with high multipath fading immunity. The device 102 is further configured with ingress protection. The device 102 has ingress protection rating of, for example, IP67, or IP68. The device 102 is configured to download a three-dimensional map of the incident environment and display to the first responder, on receiving information related to the location of the incident environment.

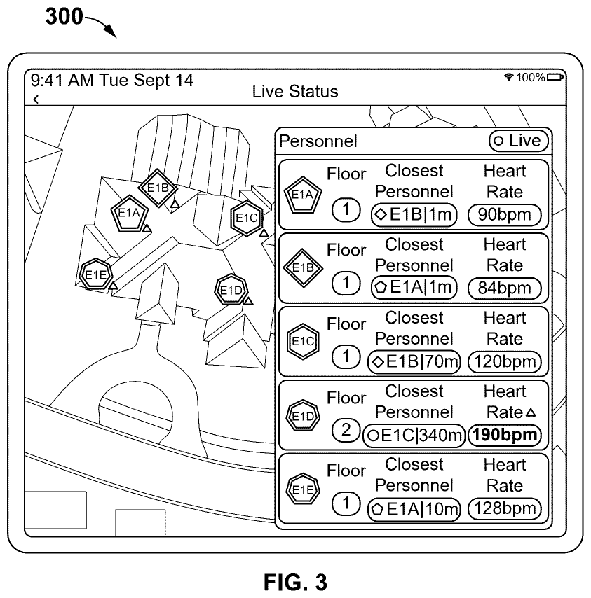

FIG. 3 exemplarily illustrates a screenshot 300 of a user interface displayed to the incident commander, according to an embodiment of the present invention. The user interface is configured to display a mock up screen of the incident environment. The user interface is configured to display data related to the first responder 104. The data includes number of first responder 104, location of each first responder 104, distance between each first responders 104, the floor at where each first responder 104 present, and orientation of the first responder 104. The data further includes if the first responder 104 is walking upright, crawling, not moving, and moving toward ceiling. The data further includes heart rate of the first responders 104. Each wearable device 102 is configured with a name. The location of the first responder 104 is indicated using the configured name, for example, E1A, E1B, E1C, E1D, and E1E.

In one embodiment, the system of the present invention is customized for the first responders 104, for example, the firefighters, war fighters, etc. The system comprises one or more wearable devices 102. Each firefighter may have the wearable device 102. Each wearable device 102 is configured with a name, for example, engine A, engine B. In another example, each wearable device 102 is configured with the code name of the firefighters. In yet another example, each wearable device 102 is configured with a name corresponding to their seats of the first responder's vehicle, for example, 4A, 4B, and 4C. 4A, 4B represents the seat behind the driver and 4C represents the driver. The device 102 is configured to provide situational awareness from the moment the firefighters are deployed to a call to till the end of the rescue operation at the incident environment. The firefighter could wear the wearable device 102 on the chest using the retractable tether. The wearable device 102 is configured to display real-time data related to each firefighter to the incident commander.

For example, if a fireball hits and firefighters are dispersed, the system is configured to enable the incident commander to track the location of the firefighters at both inside and outside environment of the building. In another example, if one firefighter (also referred as node 1) wants to know the location of another firefighter (also referred as node 2), the device 102 is configured to display the range and bearing from node 2 to the node 1. The firefighter (node 1) needs to pull the device 102 from his chest and hold the device 102 against the face shield to track the location of the firefighter (node 2).

In one embodiment, the system of the present invention is customized for the first responders 104, for example, police, war fighters and special weapons and tactics (SWAT) team. During a search warrant event, the warrants are conducted in indoor environments, for example, homes and apartments. The officer needs to go the site with the tactical team. The member of the tactical team and the officer could wear the wearable device 102. If a bad outcomes ensues, such as an officer down, the system is configured to provide situational awareness to the officer and the team. Further, the system is configured to enable the commander to track the officers and team in real time and maximize safety.

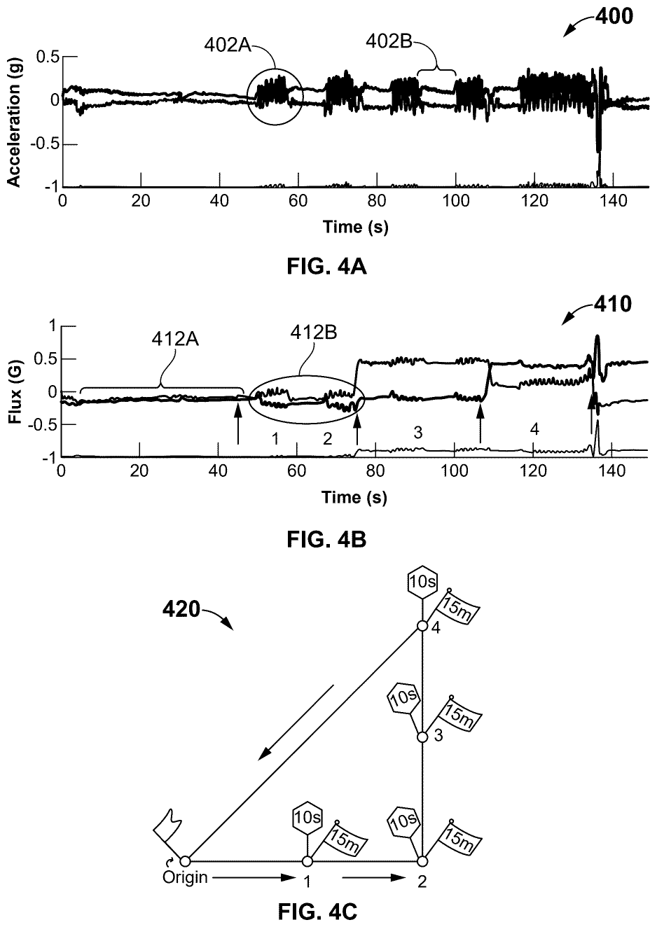

FIG. 4A exemplarily illustrates a graph 400 indicating the movement of the first responders 104 from the data of accelerometer, according to an embodiment of the present invention. The segment 402A indicates the movement of the first responder 104 and the segment 402B indicates a rest period. FIG. 4B exemplarily illustrates a graph 410 indicating the orientation of the first responders 104 from the data of magnetometer, according to an embodiment of the present invention. The segment 412A represent the rest period and the segment 412B indicates the orientation or headings of the first responder 104. FIG. 4C exemplarily illustrates a model 420 generated by tracking the movement and orientation of the first responders 104 from FIG. 4A, and FIG. 4B. The model 420 provides data related to the location, orientation, distance travelled by the responders 104, time involved to reach the distance and movement of the responders 104.

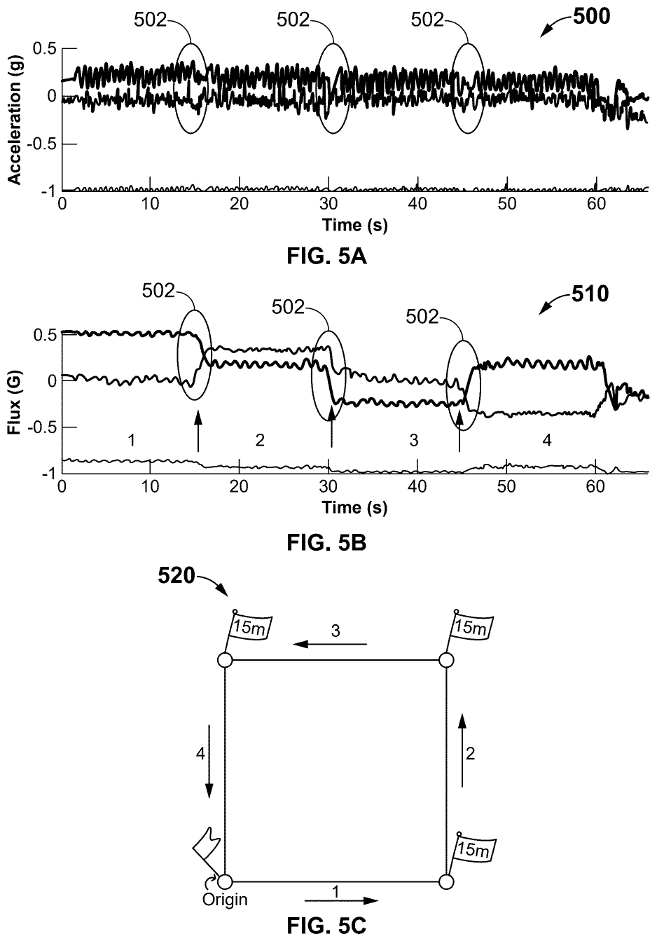

FIG. 5A exemplarily illustrates a graph 500 indicating the movement of the first responders 104 from the data of accelerometer, according to another embodiment of the present invention. FIG. 5B exemplarily illustrates a graph 510 indicating the orientation of the first responders 104 from the data of magnetometer, according to another embodiment of the present invention. The segment 502 indicates the changes in direction. FIG. 5C exemplarily illustrates a model 520 generated by tracking the movement and orientation of the first responders 104 from FIG. 5A and FIG. 5B. The model 520 provides data related to the location, orientation, distance travelled by the responders 104, time involved to reach the distance and movement of the responders 104.

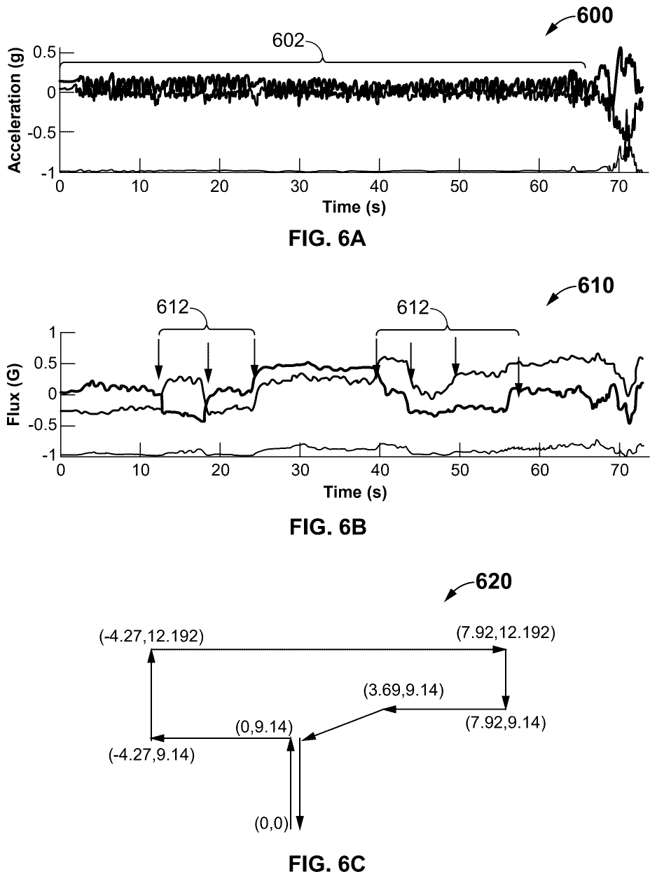

FIG. 6A exemplarily illustrates a graph 600 indicating the movement of the first responders 104 from the data of accelerometer, according to yet another embodiment of the present invention. The segment 602 represents continuous walking of the first responder 104. FIG. 6B exemplarily illustrates a graph 610 indicating the orientation of the first responders 104 from the data of magnetometer, according to yet another embodiment of the present invention. The segment 612 represents the change in direction of the first responder 104. FIG. 6C exemplarily illustrates a model 620 generated by tracking the movement and orientation of the first responders 104 from FIG. 6A and FIG. 6B. The model 620 provides data related to the location, orientation, distance travelled by the responders 104, time involved to reach the distance, movement of the responders 104 and x/y coordinates.

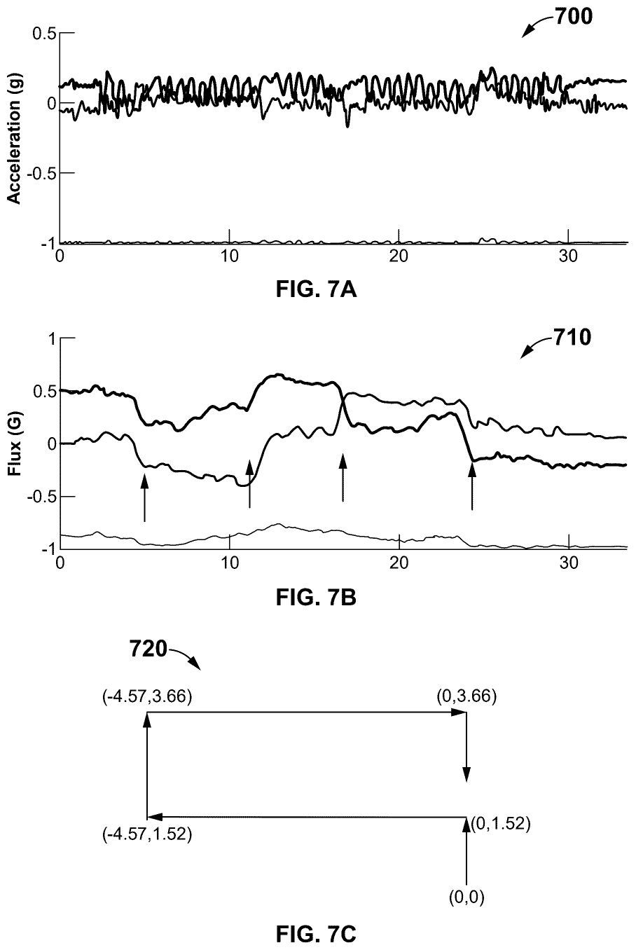

FIG. 7A exemplarily illustrates a graph 700 indicating the movement of the first responders 104 from the data of accelerometer, according to yet another embodiment of the present invention. FIG. 7B exemplarily illustrates a graph 710 indicating the orientation of the first responders 104 from the data of magnetometer, according to yet another embodiment of the present invention. FIG. 7C exemplarily illustrates a model 720 generated by tracking the movement and orientation of the first responders 104 from FIG. 7A and FIG. 7B. The model 720 provides data related to the location, orientation, distance travelled by the responders 104, time involved to reach the distance, movement of the responders 104 and x/y coordinates.

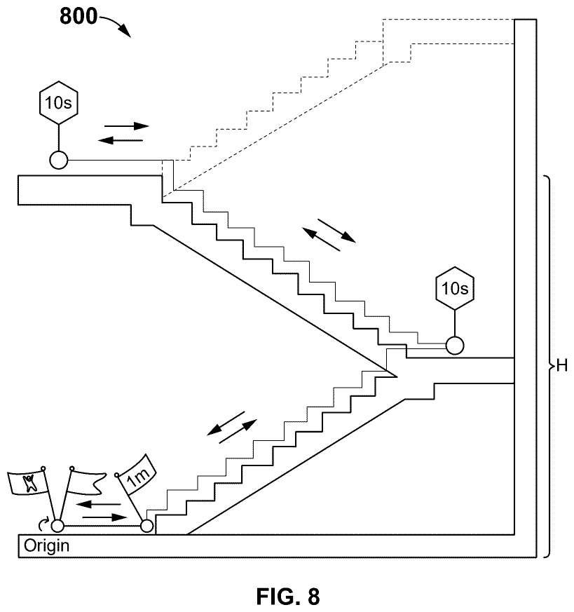

FIG. 8 exemplarily illustrates a model 800 provided by the system that represents the first responders 104 ascending and descending the stairs, according to an embodiment of the present invention. The model 800 provides information related to the height, represented as H, at where the responders 104 is located in the indoor environment. The device 102 is configured to provide location of the first responders 104 with at least 0.5 meter accuracy, or less than 0.5 meter accuracy.

The system of the present invention provides the miniaturized device 102 for tracking the location of first responders 104 in building structures above ground and underground like tunnels and basements. Further, the system is configured to facilitate three-dimensional tracking of first responders 104 at both indoor and outdoor environment. The system could be customized robustly for different type of first responders 104. The system of the present invention does not utilize pre-deployed infrastructure. The system of the present invention enhances situational awareness, safety and security, which reduces the risk faced by the first responders 104. The present invention provides a low cost, affordable system so that the technology that could be availed by any users. The system is configured to enable communication among the first responders 104 and with the incident commander.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for tracking and communicating with first responders, comprising:
one or more wearable devices, wherein each wearable device configured to communicate with other wearable devices in real time and form a wireless mesh network, wherein each wearable device associated with a first responder dispatched at an incident environment, wherein each wearable device comprises a controller, a communication module connected to the controller and an inertial measurement unit in communication with the controller, wherein each wearable device is configured to perform autonomous computing and transmit location tracking data in real-time to a computing device, wherein the location tracking data is determined using time of flight data between the wearable devices;
at least one user device associated with a second user, and
the computing device in communication with the wearable devices and the user device, wherein the computing device is configured to:
receive location tracking data of each wearable device,
enable to view location tracking data of each wearable device in real time via the user device, wherein the location tracking data includes a location of each first responder, a distance between each first responders, a floor at where each first responder is located, a distance travelled by the first responder, an orientation of the first responder and a direction of movement of the first responder, and
enable to communicate with the first responders via the user device.

2. The system of claim 1, wherein the wearable device further comprises:
one or more biometric sensors and medical sensors in communication with the controller configured to transmit health-related data of the first responder to the computing device;
a microphone in communication with the controller;
a memory in communication with the controller;
one or more connector ports in communication with the controller;
one or more control buttons in communication with the controller, wherein the control buttons are configured to enable the first responder to control the wearable device;
a power source to supply power to the wearable device;
a wireless charging module for wireless charging of the wearable device, and
at least one display in communication with the controller configured to display information related to the first responders.

3. The system of claim 2, wherein the display is an egocentric display configured to display range, bearing, azimuth and elevation of the first responders in an incident environment.

4. The system of claim 2, wherein the connector port comprises a liquid display connector port, a battery connector port, and an external device connector port.

5. The system of claim 1, wherein each wearable device comprises a unique identifier.

6. The system of claim 1, wherein the computing device is configured to:
enable the second user to view health-related data of each first responder in real time, wherein the second user is an incident commander;
display range, bearing, azimuth and elevation of the first responders with respect to a reference location at the user device;
display location tracking data and health-related data of the first responders using unique identifiers in a mock up screen of the incident environment, and
provide situational awareness from a moment the first responders are deployed to till an end of a rescue operation at the incident environment.

7. The system of claim 1, wherein the communication module comprises ultrawideband (UWB), Bluetooth (BLE) and Zigbee.

8. The system of claim 1, wherein the inertial measurement unit comprises 3 axis accelerometer, 3 axis gyroscope and magnetometer.

9. The system of claim 1, wherein the wearable device further comprises a pressure sensor, and an altimeter in communication with the controller.

10. The system of claim 1, wherein each wearable device is configured to receive and process time of flight data of a radio signal to provide location tracking data of the first responders.

11. The system of claim 1, wherein each wearable device is configured with autonomous computing and edge-computing.

12. The system of claim 1, wherein the incident environment includes indoor environment and outdoor environment.

13. The system of claim 1, wherein each wearable device is configured with multipath fading immunity and ingress protection.

14. The system of claim 1, wherein each wearable device is configured to download a three-dimensional map of the incident environment and display to the first responder, on receiving information related to the location of the incident environment.
